(19) United States
(12) Patent Application Publication
(10) Pub. No.: US 2026/0303642 A1
(43) Pub. Date: Oct. 1, 2026

(54) THREAT ASSESSMENT USING ARTIFICIAL INTELLIGENCE

(71) Applicant: Rakuten Symphony, Inc., Tokyo (JP)

(72) Inventor: Ashutosh Gupta, Bangalore (IN)

(21) Appl. No.: 19/094,158

(22) Filed: Mar. 28, 2025

(51) Int. Cl. H04L 9/40; H04L 41/16

(52) U.S. Cl. CPC H04L 63/1433; H04L 41/16

(57) ABSTRACT

A system is configured to obtain domain-specific data from a remote source and input the domain-specific data to a first generative artificial intelligence (AI) model. Processed data is received from the first generative AI model in response to the threat intelligence data. A second generative AI model is trained to make threat assessments according to the domain-specific data and the processed data. The domain-specific data may be threat intelligence data that lists at least one of hardware, software, tactics, techniques, or vulnerabilities. The threat intelligence may be obtained by scraping websites and/or making API calls.

### FIELD

The present disclosure relates to threat assessment using artificial intelligence.

### BACKGROUND

The information disclosed in this background section is only for enhancement of understanding of the general background of the disclosure and should not be taken as an acknowledgement or any form of suggestion that this information forms the prior art already known to a person skilled in the art.

Generative artificial intelligence (AI) is capable of conducting conversations and otherwise generating text in response to prompts. Such generative AI can process large amounts of data in order to provide coherent and sometimes accurate responses that appear generated by a human. With the advent of this technology, it is crucial for generative AI models to be trained on dynamic datasets while being specialized Pin domain-specific knowledge. The world is constantly changing. Information becomes outdated quickly. Training on static datasets leads to models that generate outputs based on stale knowledge. Dynamic datasets, which are continuously updated, ensure the model's knowledge remains relevant and accurate. This is especially important in fields like news, finance, or technology where information changes rapidly. Dynamic datasets allow models to adapt to new trends, patterns, and emerging information. Generative AI models trained on general datasets often lack the depth of knowledge required to generate high-quality outputs in specific domains. Domain-specific training allows the model to learn the nuances, terminology, and specific rules of a particular field, leading to more accurate and reliable results.

### SUMMARY

Conventionally, generative AI models often produce irrelevant, inaccurate, or biased outputs due to training on static, general datasets, hindering their effectiveness in specialized domains. Addressing this requires training on dynamic, domain-specific data to improve relevance, accuracy, and adaptability.

In one aspect, a system is configured to obtain domain-specific data from a remote source and input the domain-specific data to a first generative artificial intelligence (AI) model. Processed data is received from the first generative AI model in response to the domain-specific data. A second generative AI model is trained to make threat assessments according to the domain-specific data and the processed data.

In another aspect, a method includes: obtaining, by a computer system, domain-specific data from a remote source. The domain-specific data is input to a first generative artificial intelligence (AI) model. Processed data is received from the first generative AI model in response to the domain-specific data. A second generative AI model is trained to make threat assessments according to the domain-specific data and the processed data.

In another aspect, a non-transitory computer-readable medium stores executable code configured to, when executed by a computer system obtain domain-specific data from a remote source and input the domain-specific data to a first generative artificial intelligence (AI) model. Processed data is received from the first generative AI model in response to the domain-specific data. A second generative AI model is trained to make threat assessments according to the domain-specific data and the processed data.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a system for training and utilizing a domain knowledge generative AI model in accordance with an embodiment;

FIG. 2 is a process flow diagram of a method for training a domain knowledge generative AI model in accordance with an embodiment;

FIG. 3 is a process flow diagram of a method for inputting threat data to a domain knowledge generative AI model in accordance with an embodiment;

FIG. 4 is a process flow diagram of a method for utilizing a domain knowledge generative AI model in accordance with an embodiment; and

FIG. 5 is a schematic block diagram of an example computing device suitable for implementing methods in accordance with embodiments of the disclosure

### DETAILED DESCRIPTION

The following detailed description of example embodiments refers to the accompanying drawings. The present disclosure provides illustrations and descriptions but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

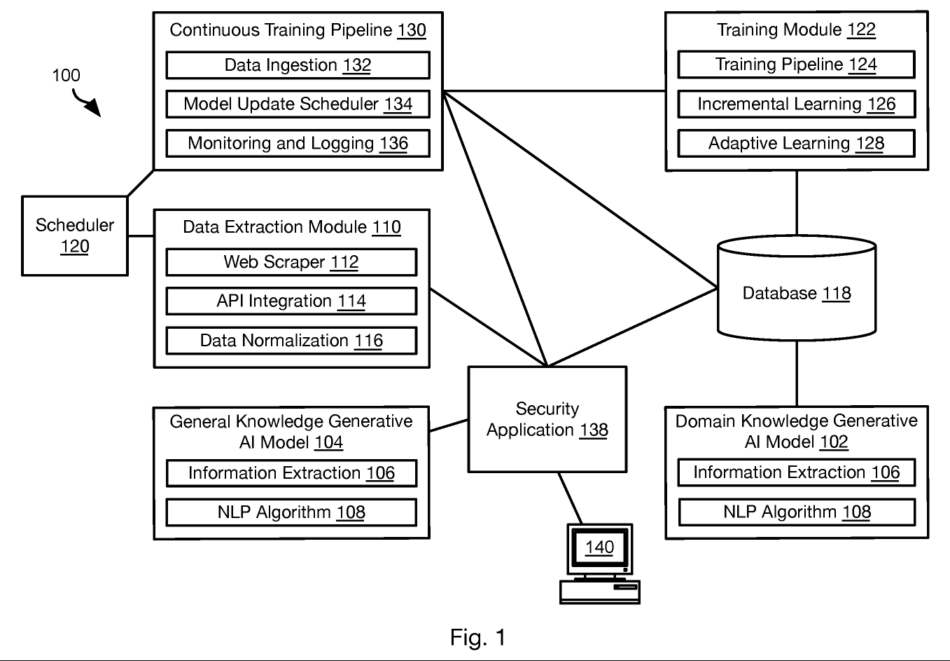

FIG. 1 illustrates a system 100 for training and utilizing a second artificial intelligence (AI) model 102 using a first AI model. For example, the second AI model 102 may be a domain-specific AI model, such as specific to threat detection or other area of specialization. The first AI model 104 is configured with capabilities to perform information extraction and a natural language processing (NLP) algorithm and may be trained with subject matter relating to a wide variety of topics as oppose to the domain-specific training of the second AI model.

The second AI model 102 may be trained to respond to prompts relating to a specific knowledge domain, namely security threats to computers and computer networks. Although first AI model 104 is particularly good at understanding the intent of prompts and outputting intelligible, accurate, and responsive answers to prompts, the first AI model 104 is not specialized with respect to a specific knowledge domain and may not have up-to-date information available to respond to prompts. Accordingly, using the approach described below, the first AI model 104 is leveraged to train the second AI model 102 to provide responses to prompts using current domain-specific knowledge.

Each of the AI models 102, 104 may include an information extraction module 106 that is configured identify and extract relevant entities and relationships from ingested data and to use such information in responding to prompts. Each of the AI models 102, 104 may include a natural language processing (NLP) algorithm 108 configured to receive prompts and generate responses to prompts by analyzing and summarizing unstructured text data. Both of the information extraction module 106 and NLP algorithm 108 may be machine learning models that are trained to perform their corresponding tasks and may undergo continuous training to improve the accuracy of responses.

The system 100 may include a data extraction module 110 that continuously (e.g., periodically) extracts threat intelligence data from various remote sources, including web scraping tools, application programming interfaces (APIs) from threat intelligence platforms, and other publicly available data sources. The components of the data extraction module 110 may include a web scraper 112 configured to scrape data from websites publishing threat intelligence data. The web scraper 112 may include one or more tools such as BEAUTIFULT SOUP, SCRAPPY, SELENIUM, or the like to extract data from websites.

The data extraction module 110 may include an API integration module 114 configured to connect to APIs of security applications to fetch threat intelligence data. The data extraction module 110 may include a data normalization module 116 that implements processes to clean and normalize extracted threat intelligence data for further processing as described in greater detail below. The threat intelligence data obtained and processed by the data extraction module 110 may be streamed to another component of the system 100 or stored in a database 118 for retrieval by another component of the system 100.

The database 118 may store the processed threat intelligence data for later retrieval. The database may additionally store model parameters defining the second AI model 102. The database 118 ensures that processed data, model parameters, and other relevant information is available for use, e.g.., training and utilization. The database 118 may include structured storage for processed data and model parameters. The database 118 may provide efficient retrieval mechanisms to access data for training and analysis. Data may be stored in the database 118 as JAVASCRIPT object notation (JSON) or extensible markup language (XML) objects. The database 118 may be implemented as a relational or non-SQL database, such as MONGODB or POSTGRESQL.

The system 100 may include a scheduler 120 that periodically triggers the functions of the data extraction module 110 in order to ensure repeated scanning of sources of threat intelligence data. The scheduler 120 may include cron jobs, which are scheduled tasks that run at specified intervals to initiate data extraction. The scheduler 120 may include event triggers, e.g., mechanisms to trigger data extraction based on specific events or conditions.

The system 100 may include a training module 122 that uses processed threat intelligence data from the data extraction module 110 to train the second AI model 102. The training module 122 may perform transfer learning and model distillation with respect to the AI models 102, 104.

This training may include fine-tuning model parameters using techniques like transfer learning and model distillation. The training module 122 may include a training pipeline 124 that feeds the processed threat intelligence data into the training module 122. The training module 122 may include an incremental learning module 126, which implements processes to update the second AI model 102 incrementally with new data.

The training module 122 may implement an adaptive learning module 128. For example, the adaptive learning module 128 may implement adaptive learning rates, e.g., techniques to optimize the training process based on the model's performance.

The training module 122 may implement the T5 (Text-to-Text Transfer Transformer) model to train the second AI model 102 in the context of threat intelligence. T5 is a transformer-based model that treats every NLP task as a text-to-text problem, making it highly versatile and effective for tasks like summarization, classification, tokenization, and named entity recognition (NER). T5 can handle multiple tasks (e.g., summarization, NER, classification) in a unified framework, which is ideal for processing threat intelligence data. T5 can be fine-tuned on domain-specific datasets, ensuring high accuracy and relevance for threat intelligence tasks. T5 is available in various sizes (small, base, large, 3B, 11B), allowing T5 to be deployed in environments with different computational resources.

Training using T5 may include preprocessing, e.g., converting all tasks into a text-to-text format. An example of a text-to-text format may include: Input: "Extract entities from: [Threat Report]" and Output: "Threat Actor: X, Malware: Y, IOC: Z." A model according to T5 that has been pre-trained may be fine-tuned on a labeled dataset of threat intelligence reports using frameworks like Hugging Face Transformers. The T5 model may be incrementally updated following fine tuning using incremental learning techniques to ensure that the T5 model remains up-to-date. The performance of the T5 model may further be validated, such as using metrics like bilingual evaluation understudy (BLEU) (for summarization) and F1-score (for NER).

The system 100 may include a continuous training pipeline 130 that may implement an automated pipeline that continuously feeds new data into the first AI model 104, processes data output in response by the first AI model 104 and updates the second AI model 102 according to the new data and the processed data.

The continuous training pipeline 130 may include a data ingestion module 132 configured to continuously ingest new data into the system 100. The continuous training pipeline 130 may include a model update scheduler 134 configured to schedule regular updates to the second AI model 102 based on new data availability. The continuous training pipeline 130 may include a monitoring and logging module 136 configured to monitor the training process and log performance metrics.

The system 100 may include a security application 138. The security application may define interfaces for submitting prompts to an AI model 102, 104 and receiving responses. The security application 138 may interface with user computing devices 140 during utilization in order to receive prompts, submit the prompts to an AI model 102 or 104, and return a response from the AI model 102, 104 to the user computing device 140.

The components of the system 100 may be implemented using parallel processing, including using techniques to process data and train models in parallel, improving efficiency and reducing training time. The components of the system 100 may be implemented using distributed computing, including leveraging distributed computing frameworks (e.g., Apache Spark) to handle large volumes of data. The components of the system 100, particularly the training module 122, may implement incremental learning such that models are updated incrementally without the need for full retraining.

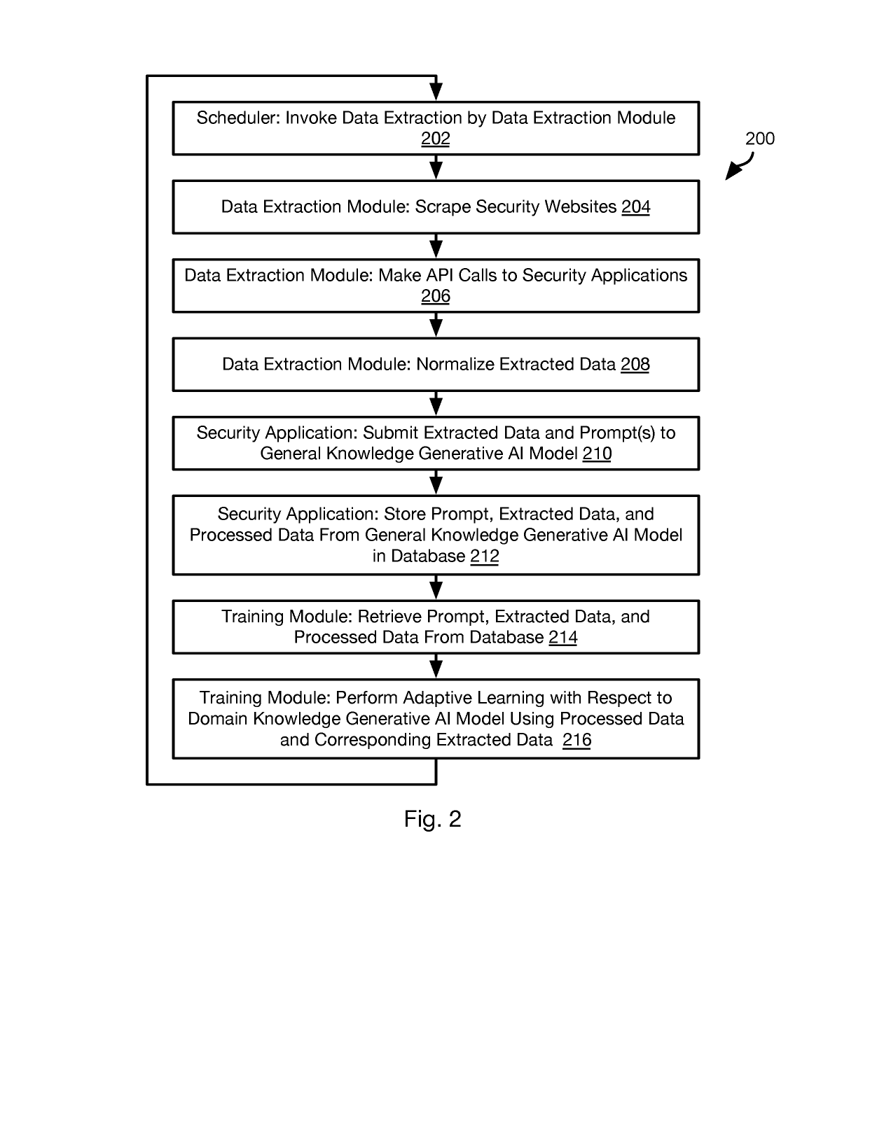

FIG. 2 illustrates a method 200 that may be performed using the system 100. The method 200 may include invoking, at step 202 by the scheduler 120, data extraction by the data extraction module 110. In response, the data extraction module 110 may then scrape security websites at step 204 and make API calls to security applications at step 206. Steps 204 and 206 may be performed in any sequence and may also be performed simultaneously and independently of one another. Extracted data collected at steps 204 and 206 may be normalized at step 208. The data collected at steps 204 and 206 may be real time data, e.g., captured close to the time of generation (e.g., within 24 hours, 2 hours, or 1 hour). The training of the second AI model 102 described below is therefore a dynamic training that adapts the second AI model to the real time data. As described in detail below, the second AI model 102 may be trained to respond to queries (e.g., prompts) based on the real time data.

The security application 138 may submit the extracted data as normalized at step 208 to the first AI model 104 at step 210. Step 210 may further include submitting a prompt with the extracted data, e.g., an instruction to generate a summary of information included in the extracted data. Since the extracted data is threat intelligence data, the prompt may request specific information such as references to vulnerable hardware and/or software, a type of vulnerability, a description of a tactic and/or technique used by a threat, names of malware or other malicious software, or other information. The prompt may be submitted with an example of threat intelligence data and a summary thereof to guide the first AI model 104.

The security application 138 may receive a response to the prompt and extracted data from the first AI model 104, e.g., “processed data.” The security application 138 may store the processed data in the database 118 at step 212. The processed data may be stored in association with the extracted data and prompt that were used to obtain the processed data at step 210.

At step 214, the training module 122 may retrieve the extracted data, prompt, and processed data from the database 118 and at step 216 the training module 122 performs adaptive learning with respect to the second AI model 102. In particular, the training module 122 may use the extracted data, prompt, and processed data to train the second AI model 102 to one or both of (a) generate a summary from threat intelligence data (e.g., generate the processed data based on the extracted data) and (b) to understand and respond to prompts.

The method 200 may be repeated any number of times in order to train the second AI model 102. In some embodiments, a large corpus of training data entries is assembled before training is performed at step 216, each training data entry including extracted data and processed data and possibly a prompt.

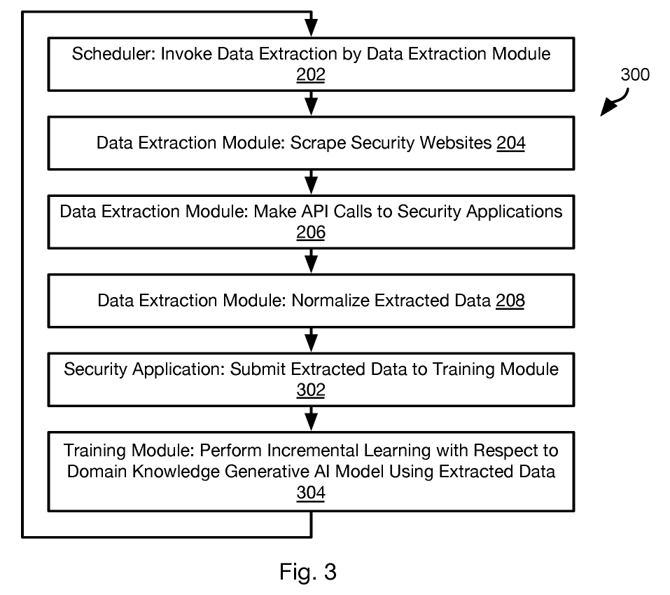

Referring to FIG. 3, the system 100 may be used to perform the illustrated method 300. The method 300 may include obtaining extracted data, e.g., threat intelligence data, such as by performing steps 202-208 as described above. The method 300 may be performed with respect to different threat intelligence data than the method 200, e.g., second threat intelligence data received subsequent to first threat intelligence data processed according to the method 200.

The security application 138 may submit the extracted data to the training module 122 at step 302. The security application 138 may do so directly or by way of the database 118. At step 304, the training module 122 uses the extracted data to perform incremental learning with respect to the second AI model 102. In particular, step 304 may relate to supplying the second AI model 102 with additional information that may subsequently be used when responding to prompts. For example, step 304 may include invoking the information extraction module 106 of the second AI model 102. In contrast, the method 200 may relate to training the second AI model 102 with the ability to understand and respond to prompts. For example, the method 200 may relate to training the NLP algorithm 108 of the second AI model 102. The method 300 may begin to be performed after the method 200 has been performed a sufficient number of times, e.g., after the monitoring and logging module 136 determines that the second AI model 102 has achieved a predefined level of accuracy in performing text-to-text tasks. The method 200 may stop being performed when the method 300 is being performed or may be interleaved with iterations of the method 300.

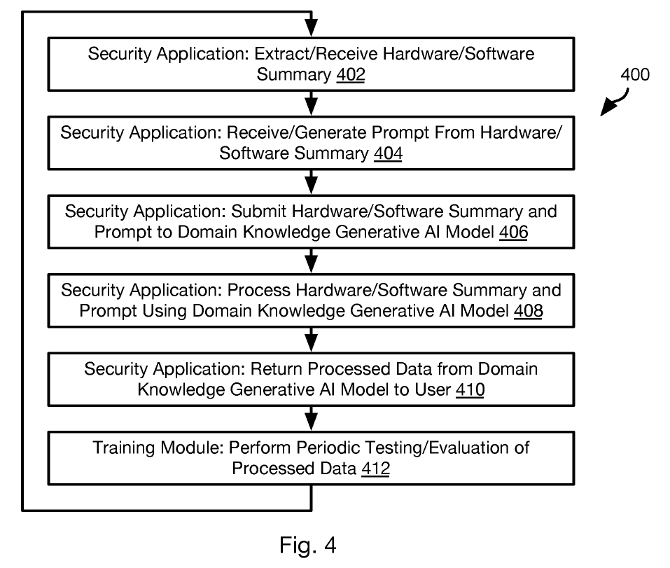

FIG. 4 illustrates a method 400 that may be performed using the system 100. The method 400 may be executed in order to utilize the second AI model 102 following training according to the methods 200, 300.

At step 402 the security application 138 extracts or receives a hardware and/or software summary. The hardware and/or software summary may describe a specific computer system or a set of nodes in a computer network. The hardware and/or software summary may be human generated or may be automatically generated. For example, the security application 138 or some other component may scan nodes of a computer network to obtain a description of hardware (processors, memory, storage devices, network controller, etc.) and/or software (operating system, applications, services, etc.) of each node. A hardware and/or software summary may be generated automatically, such as using either of the AI models 102, 104 or a different generative AI model specifically trained to perform this task.

At step 404, the security application 138 may generate a prompt referencing the hardware and/or software summary. For example, the prompt may include a request to identify any known vulnerabilities and/or malware for hardware and/or software referenced in the hardware and/or software summary.

At step 406, the security application 138 may submit the hardware and/or software summary to the second AI model 102, possibly with the prompt.

At step 408, the security application 138 or other component processes the hardware and/or software summary and possibly the prompt from step 406 using the second AI model 102. At step 410, the security application 138 receives processed data that is a result of the processing of step 408, e.g., a summary of threat intelligence data relating to the hardware and/or software listed in the hardware and/or software summary and returns the result to a user, e.g., to a user computing device 140. Step 410 may be include returning the processed data to a source of the hardware and/or software summary at step 402.

The method 400 is exemplary only. Various approaches to utilizing the second AI model 102 may be used. For example, a prompt alone may be submitted that requests a summary of threat intelligence data. Data extracted by the data extraction module 110 may be submitted with a prompt requesting generation of a summary thereof.

The method 400 may include periodically performing, at step 412, testing and/or evaluating of processed data output by the second AI model 102. For example, the training module 122 may perform this step as part of ongoing training of the second AI model 102. Evaluating may include evaluating using the functions of the monitoring and logging module 136 as described above, comparing the processed data to an output of the first AI model 104, or other approach.

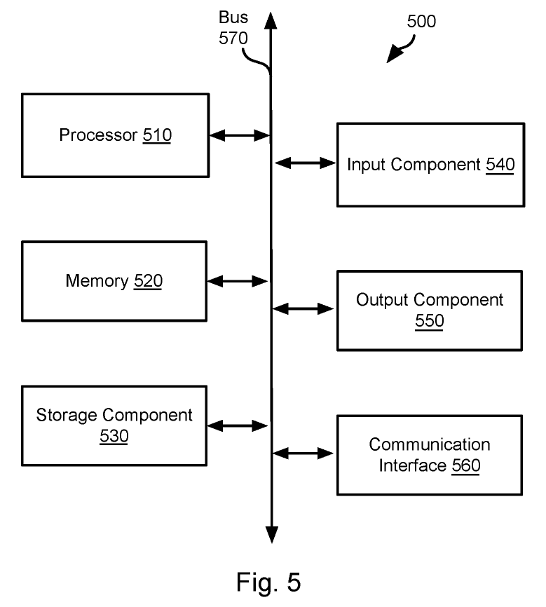

FIG. 5 illustrates an embodiment of a computing device 500 that may be used to implement some or all of the components of the system 100. As shown in FIG. 5, the device 500 includes a processor 510, a memory 520, a storage component 530, an input component 540, an output component 550, a communication interface 560, and a bus 570.

The processor 510, as used herein, means any type of computational circuit that may comprise hardware elements and software elements. The processor 510 may be embodied as a multi-core processor, a single core processor, or a combination of one or more multi-core processors and/or one or more single core processors, a distributed processing system, or the like. The processor 510 may be a Central Processing Unit (CPU), a graphics processing unit (GPU), an accelerated processing unit (APU), an application-specific integrated circuit (ASIC), or another type of processing component.

Memory 520 includes a non-transitory computer readable medium. Memory 520 includes a random-access memory (RAM), a read only memory (ROM), and/or another type of dynamic or static storage device (e.g., a flash memory, a magnetic memory, and/or an optical memory) that stores information and/or instructions for use by processor 510. The memory 520 comprises machine-readable instructions which are executable by the processor 510. These machine-readable instructions when executed by the processor 510 cause the processor 510 to perform one or more method steps of an embodiment described above.

Storage component 530 stores information and/or software related to the operation and use of the device 500. For example, storage component 530 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 540 is configured to receive information, such as user input. For example, the input component 540 may include, but not be limited to, a touch screen display, a keyboard, a keypad, a mouse, a button, a switch, and/or a microphone. Additionally, or alternatively, the input component 540 may include a sensor for sensing information (e.g., a global positioning system (GPS), an accelerometer, a gyroscope, and/or an actuator).

Output component 550 is configured to provide output information from the device 500. For example, the output component 550 may be, but not limited to, a display, a speaker, instructions to an external device, and/or one or more light-emitting diodes (LEDs).

Communication interface 560 is an interface that provides a communication connection to other devices, such as external devices and internal devices. The connection by the communication interface 560 can be a wired connection, a wireless connection, or a combination of wired and wireless connections, and can be a direct connection or an indirect connection via a communication network that exists between the device 500 and other devices. In other words, the standard of the communication interface 560 is not limited.

The bus 570 acts as an interconnect between the processor 510, the memory 520, the storage component 530, the input component 540, the output component 550, and the communication interface 560 of the device 500. The bus 570 may include a wired interconnection or a wireless interconnection.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500. Further, one or more method steps described in any of the embodiments may be performed utilizing a plurality of devices 500 in communication with one another.

In a first example embodiment, a system is configured to: obtain domain-specific data from a remote source; input the domain-specific data to a first generative artificial intelligence (AI) model; receive processed data from the first generative AI model in response to the domain-specific data; and train a second generative AI model to make threat assessments according to the domain-specific data and the processed data.

In a second example embodiment of the first example embodiment, the domain-specific data is real time data and the system is further configured to dynamically train the second generative AI model based on the real time data.

In a third example embodiment of the second example embodiment, the system is further configured to train the second generative AI model to respond to user queries based on the real time data.

In a fourth example embodiment of the first example embodiment, the domain-specific data is threat intelligence data.

In a fifth example embodiment of the fourth example embodiment, the domain-specific data lists at least one of hardware or software and at least one of tactics, techniques, or vulnerabilities.

In a sixth example embodiment of the first example embodiment, the system is further configured to retrieve the domain-specific data by at least one of (a) scraping a website or (b) making calls to an application programming interface.

In a seventh example embodiment of the first example embodiment, the system is configured to train the second generative AI model by training a natural language processing (NLP) algorithm of the second generative AI model.

In an eighth example embodiment of the seventh example embodiment, the domain-specific data is first domain-specific data and the system further configured to; receive second domain-specific data subsequent to the first domain-specific data; and perform data extraction with respect to the second domain-specific data using the second generative AI model.

In a ninth example embodiment of the eight example embodiment, the system is further configured to: receive a prompt; and generate a threat assessment in response to the prompt using the second generative AI model.

In an eleventh example embodiment of the ninth example embodiment,

In a twelfth example embodiment, a method includes: obtaining, by a computer system, domain-specific data from a remote source; inputting, by the computer system the domain-specific data to a first generative artificial intelligence (AI) model;

receiving, by the computer system, processed data from the first generative AI model in response to the domain-specific data; and training, by the computer system, a second generative AI model to make threat assessments according to the domain-specific data and the processed data.

In a thirteenth example embodiment of the twelfth example embodiment, the domain-specific data is real time data, the method further comprising dynamically training, by the computer system, the second generative AI model based on the real time data.

In a fourteenth example embodiment of the thirteenth example embodiment, the method further includes training, by the computer system, the second generative AI model to respond to user queries based on the real time data.

In a fifteenth example embodiment of the twelfth example embodiment, the domain-specific data is threat intelligence data.

In a sixteenth example embodiment of the fifteenth example embodiment, the domain-specific data lists at least one of hardware or software and at least one of tactics, techniques, or vulnerabilities.

In a seventeenth example embodiment of the twelfth example embodiment, the method further includes retrieving, by the computer system, the domain-specific data by at least one of (a) scraping a website or (b) making calls to an application programming interface.

In an eighteenth example embodiment of the twelfth example embodiment, training the second generative AI model comprises training a natural language processing (NLP) algorithm of the second generative AI model; and the domain-specific data is first domain-specific data the system further configured to: receive second domain-specific data subsequent to the first domain-specific data; and perform data extraction with respect to the second domain-specific data using the second generative AI model.

In a nineteenth example embodiment of the eighteenth example embodiment, the method further includes: receiving, by a computer system, a prompt; and generating, by the computer system a threat assessment in response to the prompt using the second generative AI model; wherein the prompt includes at least one of a hardware summary and a software summary and the threat assessment includes one or more vulnerabilities corresponding to the at least one of the hardware summary and the software summary.

In a twentieth example embodiment, a non-transitory computer-readable medium storing executable code that, when executed by one or more processing devices, causes the one or more processing devices to: obtain domain-specific data from a remote source; input the domain-specific data to a first generative artificial intelligence (AI) model; receive processed data from the first generative AI model in response to the domain-specific data; and train a second generative AI model to make threat assessments according to the domain-specific data and the processed data.

1. A system configured to:
obtain domain-specific data from a remote source;
input the domain-specific data to a first generative artificial intelligence (AI) model;
receive processed data from the first generative AI model in response to the domain-specific data; and
train a second generative AI model to make threat assessments according to the domain-specific data and the processed data.

2. The system of claim 1, wherein the domain-specific data is real time data and the system is further configured to dynamically train the second generative AI model based on the real time data.

3. The system of claim 2, wherein the system is further configured to train the second generative AI model to respond to user queries based on the real time data.

4. The system of claim 1, wherein the domain-specific data is threat intelligence data.

5. The system of claim 4, wherein the domain-specific data lists at least one of hardware summary or software summary and at least one of tactics, techniques, or vulnerabilities.

6. The system of claim 1, wherein the system is further configured to retrieve the domain-specific data by at least one of scraping a website and making calls to an application programming interface.

7. The system of claim 1, wherein the system is configured to train the second generative AI model by training a natural language processing (NLP) algorithm of the second generative AI model.

8. The system of claim 7, wherein the domain-specific data is first domain-specific data and the system further configured to:
receive second domain-specific data subsequent to the first domain-specific data; and
perform data extraction with respect to the second domain-specific data using the second generative AI model.

9. The system of claim 8, further configured to:
receive a prompt; and
generate a threat assessment in response to the prompt using the second generative AI model.

10. The system of claim 9, wherein the prompt includes a hardware summary and the threat assessment includes one or more vulnerabilities corresponding to the hardware summary.

11. The system of claim 9, wherein the prompt includes a software summary and the threat assessment includes one or more vulnerabilities corresponding to the software summary.

12. A method comprising:
obtaining, by a computer system, domain-specific data from a remote source;
inputting, by the computer system, the domain-specific data to a first generative artificial intelligence (AI) model;
receiving, by the computer system, processed data from the first generative AI model in response to the domain-specific data; and
training, by the computer system, a second generative AI model to make threat assessments according to the domain-specific data and the processed data.

13. The method of claim 12, wherein the domain-specific data is real time data, the method further comprising:
dynamically training, by the computer system, the second generative AI model based on the real time data.

14. The method of claim 13, further comprising training, by the computer system, the second generative AI model to respond to user queries based on the real time data.

15. The method of claim 12, wherein the domain-specific data is threat intelligence data.

16. The method of claim 15, wherein the domain-specific data lists at least one of hardware or software and at least one of tactics, techniques, or vulnerabilities.

17. The method of claim 12, further comprising retrieving, by the computer system, the domain-specific data by at least one of (a) scraping a website or (b) making calls to an application programming interface.

18. The method of claim 12, wherein:
training the second generative AI model comprises training a natural language processing (NLP) algorithm of the second generative AI model; and
the domain-specific data is first domain-specific data the system further configured to:
receive second domain-specific data subsequent to the first domain-specific data; and
perform data extraction with respect to the second domain-specific data using the second generative AI model.

19. The method of claim 18, further comprising:
receiving, by the computer system, a prompt; and
generating, by the computer system, a threat assessment in response to the prompt using the second generative AI model;
wherein the prompt includes at least one of a hardware summary and a software summary and the threat assessment includes one or more vulnerabilities corresponding to the at least one of the hardware summary and the software summary.

20. A non-transitory computer-readable medium storing executable code that, when executed by one or more processing devices, causes the one or more processing devices to:
obtain domain-specific data from a remote source;
input the domain-specific data to a first generative artificial intelligence (AI) model;
receive processed data from the first generative AI model in response to the domain-specific data; and
train a second generative AI model to make threat assessments according to the domain-specific data and the processed data.
